(19) United States
(12) Patent Application Publication
(10) Pub. No.: US 2010/0172624 A1
(43) Pub. Date: Jul. 8, 2010

(54) VIDEO CAPTURE, PLAYBACK AND ANALYSIS TOOL

(75) Inventor: LARRY WATTS, Gloucester, MA (US)

Correspondence Address: WOLF GREENFIELD & SACKS, P.C., 600 ATLANTIC AVENUE, BOSTON, MA, 02210-2206, US

(73) Assignee: ProMirror, Inc., Gloucester, MA (US)

(21) Appl. No.: 12/689,378

(22) Filed: Jan. 19, 2010

Related U.S. Application Data
(63) Continuation of application No. 11/788,743, filed on Apr. 20, 2007, now abandoned.
(60) Provisional application No. 60/793,819, filed on Apr. 21, 2006.

(51) Int. Cl. H04N 5/93; G06F 3/01

(52) U.S. Cl. 386/52; 715/702; 386/E05.003; 715/810; 715/716

(57) ABSTRACT

An integrated system provides almost immediate feedback to a person performing an action of the performed action. In some embodiments, the system includes a camera or other image capturing device, a user interface such as a touch screen, a sunlight-readable display, triggers, and software. Systems and methods described herein may used by athletes and/or instructors who desire feedback without delay when working to improve athletic motions.

In some embodiments, the user interface may be icon-based, such that the action occurs in response to the user touching an icon. One or more icons of the user interface may be generated as video data is captured, and the graphical content of each icon may include video data collected from the image capturing device.

### RELATED APPLICATION

This application is a continuation of and claims priority to U.S. application Ser. No. 11/788,743 filed Apr. 20, 2007 which claims benefit under 35 U.S.C. § 119(e) to U.S. Provisional Application Ser. No. 60/793,819, entitled “Video Capture, Playback and Analysis Tool”, filed on Apr. 21, 2006, which is hereby incorporated by reference in its entirety.

### SUMMARY

Described herein is a system (e.g., tool) and methods for capture, playback and analysis of video. The system and methods described herein may have any of a plurality of applications, including the capturing and reviewing of a recording of a person performing an action. For example, the system and methods may be used for athletes and instructors who desire substantially immediate feedback while working on improving athletic skills.

In some embodiments of the invention, an integrated system is provided that provides substantially immediate feedback of a person performing an action, integrating any of: a computer; a touch screen; a sunlight-readable display; a camera; triggers; software; other components; and any suitable combination of the foregoing.

Embodiments of the invention may have any of several benefits. For example, the system may be used in an environment where athletes are working on skill improvement, e.g., a baseball player working on his/her pitching skills. In this example, the system may be set up right next to a pitching mound where a display of the system is viewable by a pitcher immediately after the pitch is thrown (e.g., within one second). By providing such data to the athlete in an environment where the athlete is working on improving skills, the potential for rapid skill improvement is achieved.

Another benefit that may be provided in embodiment of the invention is ease of use. An operating system may be provided by an easy-to-use touch-screen interface. Control buttons that the user may touch may be video images created when the data is captured. For example, when a baseball player on a pitching mound throws a fastball, the player then may turn towards the system and touch the picture of the fastball being pitched. The system then may playback the pitch and allow the user to analyze the user's motion. The system may be configured so that minimal computer skills and/or language skills are required to operate the system. Such a system provides numerous advantages over existing systems, where typically extensive training, significant computer skills, purchase of many components and/or an entirely different use model are required.

For example, known systems often require that someone take a video camera to an environment at which skills are being developed. The person with the video camera films the entire session of the athlete working on their skills. After the session is completed, the athlete in the video leave the field of play and enter a room where a computer is set up. The video data is loaded into the computer and then viewed for analysis. Thus, the athlete has been removed from the environment where the skills were being developed, and the expertise of a computer operator is required to display meaningful data. Embodiments of the invention described herein do not have these requirements.

The system and methods described herein may be used for any variety of applications such as, for example, sports, including baseball, tennis and golf, at any level, including professional and amateur levels, or for analyzing other human actions, or even other non-human actions.

In some embodiments of the invention, one or more components of a user interface are generated as video data is captured. The user interface may be icon-based, such that the action occurs in response to the user touching an icon. The graphical content of each icon may include video data collected from the video captured.

In some embodiments of the invention, a grid of video frames may be displayed, each frame is representing a frame of a same video sequence. A user interface may be configured to enable a user to control the content of the grid including, playing, pausing, stepping, overlaying and measuring data projected on the grid.

In some embodiments of the invention, video is fed from a video source into a system. The video may be streamed through a memory buffer (e.g., by a user) to hold a certain amount of video data such as, for example, as small as 0.5 seconds or less, or as great as one minute of video data or more. In response to a user activating a trigger event, the memory buffer may be saved to disk as a file for future playback.

In some embodiments of the invention, an integrated video capture, playback and analysis system is provided. The system may include any of: a computer, touch screen, sunlight-readable display; triggers; camera; mounting device; other components; and any suitable combination of the foregoing, any number of which (e.g., all) may be packaged into a single system.

In some embodiments of the invention, customers may submit video footage of their athletic performance to be analyzed by a professional instructor or coach. The video may be fed into a system (e.g., an integrated system as described above), and an instructor may analyze the video using the system, point out flaws and make suggestions for improvement. The analysis then may be recorded on a DVD, VCR or other recording device and a product (e.g., disk, tape, memory stick, etc.) storing the recorded analysis may be sold to the customer. For example, the product may include the analysis overlaid on the original video footage.

In some embodiments, a kiosk encompassing an implementation of the system described herein may be placed at locations such as airports, hotels, shopping malls, sporting events, concerts, carnivals, circuses, arenas, marketplaces, or other events or locations. For a fee, customers may be enabled to perform athletic skills and analyze their performance using the system.

In some embodiments of the invention, an implementation of the system described herein may be placed on a desk of a TV sports broadcaster. The video may be fed into the system from a live video feed that is also being provided to home viewers. The broadcaster may capture significant video data from the live video feed, play it back and analyze it for the home viewers.

According to one embodiment of the invention, a system for capturing and reviewing a recording of a person performing an action includes an image capturing device to capture the recording of the action, a display device having a touch screen, and a user interface to control a display of the recording on the display device, and to enable a user to manipulate the presentation of the recording using the touch screen. The system further includes at least one transmission medium enabling communication between the image capturing device to the user interface and at least one mounting mechanism to mount the image capturing device and the touch screen display in a location proximate to the person.

According to another embodiment of the invention, a system for enabling a user to review, on a visual display device having a touch screen, a visual recording of a person performing an action, includes a user interface to control a display of the recording on a display device and to enable a user to manipulate the presentation of the recording using the touch screen. The display includes a main display of a primary presentation of the recording, a plurality of user-selectable playback controls, one or more user-selectable manipulation icons for manipulating a presentation of the recording in the main display, and one or more user-selectable file icons, each file icon representing a particular recording and enabling a user to select the particular recording for display in the main display.

According to a further embodiment of the invention, a system for controlling a recording of footage of a person performing an action includes an image recording controller to receive, concurrently to a capturing of a portion of the footage by an image capture device, one or more video signals from the image capturing device, the one or more signals representing at least a portion of the footage, the image recording controller operative to temporarily buffer the one or more video signals in memory. The system also includes a triggering controller to control, in response to the capturing of a sound having a particular one or more characteristics, a stopping of the buffering of the one or more video signals and a storing of the buffered one or more video signals on a non-volatile recording medium.

According to another embodiment of the invention, a system is provided for enabling a user to review, on a display device having a touch screen, a recording of a person performing an action during a first temporal period, the recording including a plurality of frames, and each frame captured at a different time during the temporal period. The system includes a user interface to control a display of the recording on a display device and to enable a user to manipulate the presentation of the recording using the touch screen, the display comprising at least a first user-selectable control to select a displaying of two or more of the plurality of the frames simultaneously. The user interface is operable, in response to a user selecting the at least first user-selectable control, to simultaneously display two or more of the plurality of the frames in an arrangement according to a temporal order of the two or more of the plurality of frames.

According to a further embodiment of the invention, a method of practicing an athletic action includes performing the athletic action at a first location while an image capturing device captures a recording of the athletic action. The method further includes, within one minute of the performance of the athletic action, reviewing the recording on a display device having a touch screen disposed at a second location in close proximity of the first location, including manipulating the presentation of the recording using the touch screen.

According to another embodiment of the invention, a method of generating revenue at a venue of an athletic event corresponding to a type of athletic activity includes capturing a recording of a person performing an athletic action associated with the type of athletic activity, displaying the recording to the person on a display device, and charging a fee to the person for the capturing and displaying.

Other advantages, novel features, and objects of the invention, and aspects and embodiments thereof, will become apparent from the following detailed description of the invention, including aspects and embodiments thereof, when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment or aspect of the invention shown where illustration is not necessary to allow those of ordinary skill in the art to understand the invention.

### BRIEF DESCRIPTION OF THE DRAWINGS

FIG. 1 is a schematic diagram of a system for video capture, playback and analysis, according to some embodiments of the invention;

FIG. 2 illustrates an example of a system for video capture playback and analysis, according to some embodiments of the invention;

FIG. 3 is a diagram illustrating an example of a system head, according to some embodiments of the invention;

FIG. 4 is a block diagram illustrating a system for capturing video for playback and analysis, according to some embodiments of the invention;

FIG. 5 is a block diagram illustrating an example of a video player for playing back captured video for analysis, according to some embodiments of the invention; and

FIGS. 6-9 each are screen shots illustrating an example of a video player, according to some embodiments of the invention.

### DETAILED DESCRIPTION

The function and advantage of embodiments of the present invention will be more fully understood from the examples described below. The following examples are intended to facilitate a better understanding and illustrate the benefits of the present invention, but do not exemplify the full scope of the invention.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Eighth Edition, Revision 2, May 2004), Section 2111.03.

### EXAMPLES

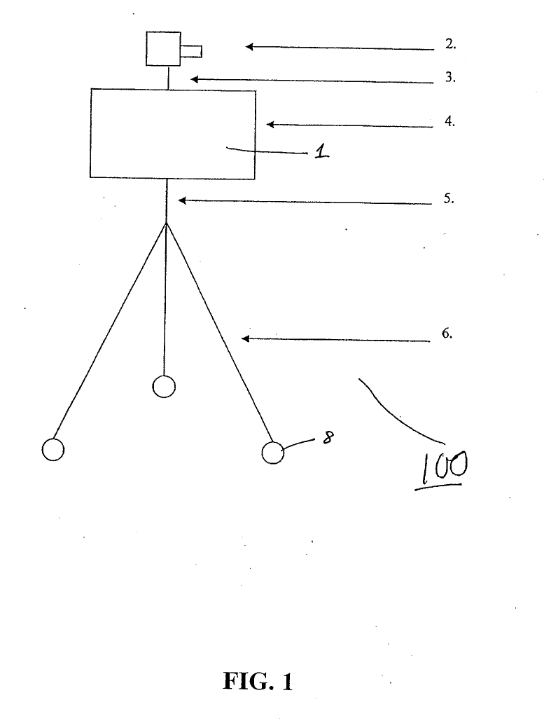

FIG. 1 is a very schematic diagram of a system 100 for video capture, playback and analysis, according to some embodiments of the invention. As shown in FIG. 1, the system may include any of: a camera 2; a mounting device 3; a system head 4 including a display 1; a mounting device 5; a foldable tripod 6 with wheels 8; other components; and any suitable combination of the foregoing. Display 1 may include a display screen having anti-reflective glass to permit viewing in bright sunlight. In some embodiments, system 100 may include an adjustable umbrella (not shown) to improve viewing in bright sunlight conditions.

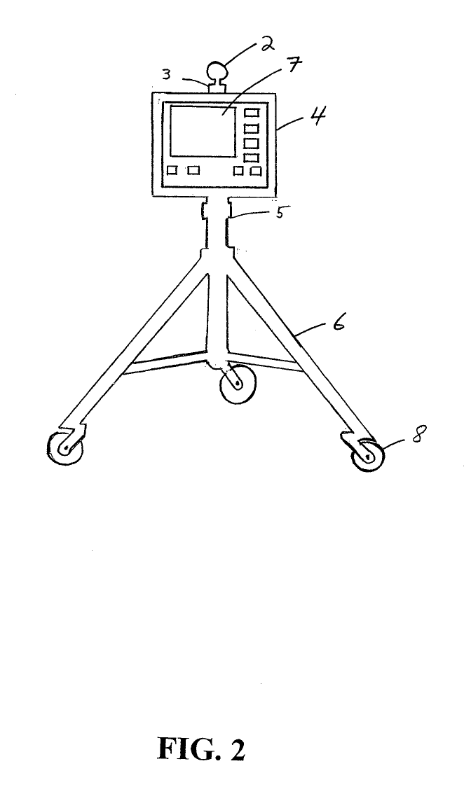

FIG. 2 illustrates an example of a system for video capture playback and analysis, according to some embodiments of the invention. Camera 2 is mounted with mounting device 3 to system head 4. System head 4 includes display screen 7, which may be a touch sensitive screen. System head 4 is mounted via mounting device 5 to foldable tripod 6. Tripod 6 may include wheels 8 for portability.

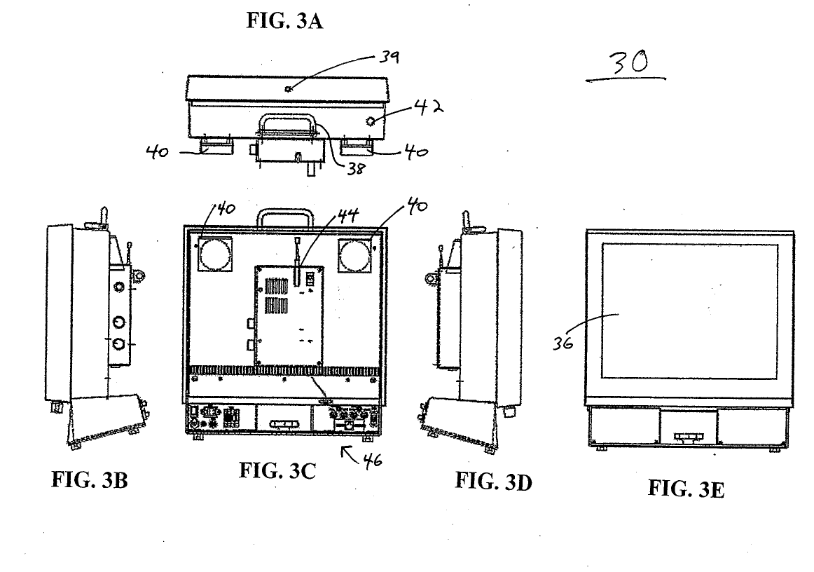

FIGS. 3a-3e are diagrams illustrating one example of a system head 30 (e.g., for use as system head 4 with the system of FIG. 1) according to some embodiments of the invention. FIGS. 3a-3e include a top view, a right side view, a back view, a left side and a front view, respectively.

System head 30 may contain a computer with memory, a CPU, a disk, a video capture card, a video broadcast card and/or any other suitable computer components. System head 30 also may include a touch screen display 36, which may have high brightness capabilities for viewing in bright sunlight. Other implementations of the system head may be realized and are intended to fall within the scope of the invention.

The top view of FIG. 3a illustrates that the system head may include any of: a handle 38 for carrying the system; a mounting device 39 to support a camera; covers 40 for fans to protect from rain and dust; and an antenna hole 42 for a wireless microphone receiver.

The back view of FIG. 3c shows in more detail fan covers 40 and a wireless microphone receiver 44. FIG. 3c also shows an I/O panel 46 on the bottom of the system head. The I/O panel may have connectors for plugging in one or more (e.g., two) camera video cables, one or more (e.g., two) power sources to supply power to the camera, one or more (e.g., two) video and audio outputs such as, for example, one for a local feed, one for remote broadcast of video and audio to any NTSC capable device, one or more (e.g., two) network connectors, one or more (e.g., one) trigger connector and an on/off switch.

Surge protectors, backup batteries, and/or other power management components may be included to protect the system in the event of a power failure or a power spike. In some embodiments, the system operates on AC power from a standard electricity source, while in other embodiments, the system is adapted to operate using battery power and/or other suitable source of power.

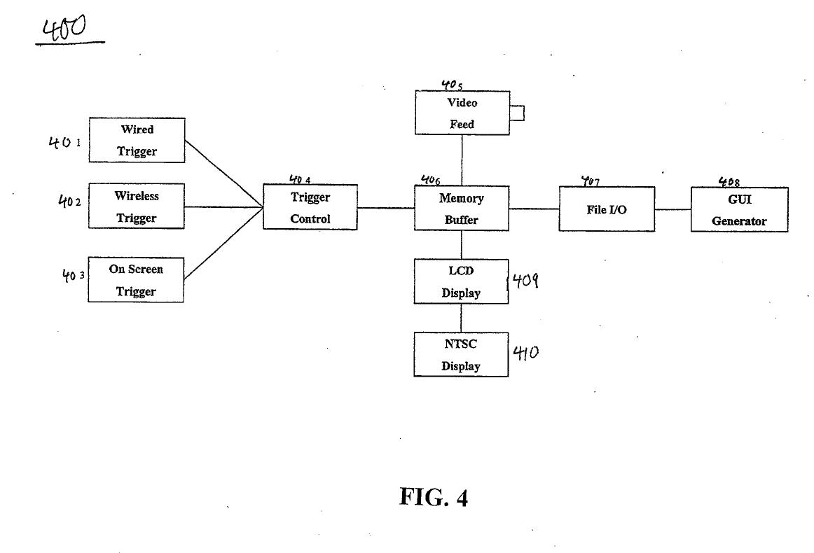

FIG. 4 is a block diagram illustrating a system 400 for capturing video (e.g., analog and/or digital video signals) for playback and analysis, according to some embodiments of the invention. Other embodiments of the video capture system may be realized and are intended to fall within the scope of the invention.

In embodiments of the invention, when in video capture mode, live video may be transmitted into system 400 from a live video feed. This video may be displayed onto screen 409, and may stream through a memory buffer 406. When a user of the system activates a trigger mechanism (e.g., any of 401, 402 and/or 403), a trigger control component 404 may tell the system to save the video that is currently in memory buffer 406 to a file I/O component 407, such as a disk or other recording medium. Further, serially or concurrently to saving the video, trigger control component 404 may control the creation of an array of controls from the video data, which may be used during video playback. The size of memory buffer 406 may be configurable (e.g., by a non-technical user or a programmer) to allow the buffer to save video in increments of time. For example the increments of time can be as little as 1/30 of one second or less, or as large as 60 seconds or more.

As shown above, trigger mechanisms 401, 402 and 403 may include any of wired and wireless devices that inform the system 400 to activate a trigger event. The wire devices may include a foot pedal, a hand-held button, a mouse, a joystick, a microphone that detects known sounds for which a trigger event is desired (e.g., a baseball bat or golf club hitting a ball); other wired components; or any suitable combination of the foregoing. The wireless mechanisms may include a hand-held trigger, a hand-held button, a mouse, a joystick, a sound-activated trigger, other wireless components, or any combination of the foregoing.

A GUI generator 408 may create files, which may be pictures and may be used as control buttons during video playback. These pictures may be frames from the video that was saved to disk during a triggering event. The pictures may include a middle frame (or other frame) of a video clip that was saved, and may be manipulated to assist the user in controlling the video clip as it is played back. GUI generator 408 may be configured to display pictures in any of a variety of manners, including, but not limited to: a captured video scene horizontally reversed; a video scene with a grid overlaid on top of the video scene; a video scene laid out in a sequence of individual frames; a video scene with a speedometer overlaid on top of the image; the video scene split to show two side-by-side video clips; a video scene with areas blacked out; a video scene with stick figures overlaid; a video scene with a tape measure overlaid; other variations of the video scene; or any suitable combination of the foregoing.

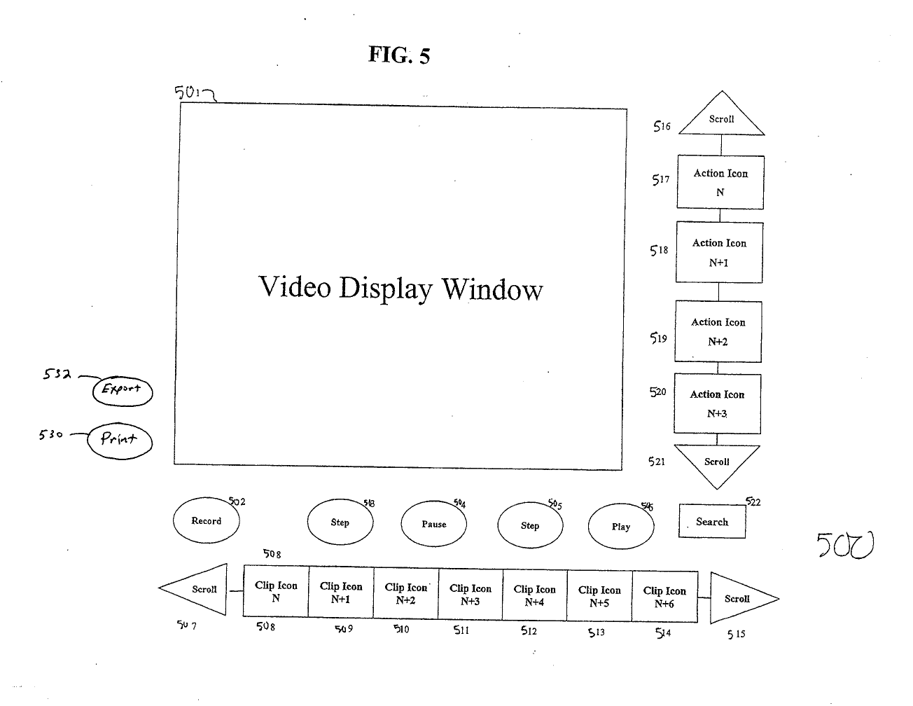

FIG. 5 is a block diagram illustrating an example of a video player 500 for playing back captured video for analysis on a video display window 501, according to some embodiments of the invention. Other implementations of a video player may be realized and are intended to fall with in the scope of the invention.

In the video player mode of the system, video player 500 may provide the user with the ability to instantly review video data that was just captured, and to perform detailed analysis of the motion captured on the video data. Player 500 may include controls for performing any of a variety of functions. For example, player 500 may include any of: a control 504 for pausing video; a control 506 for playing video; a control 505 for stepping forward through video; a control 503 for stepping backward through video; a control 502 for returning to a record mode; a control 522 for searching for videos by an identifier; other controls; or any suitable combination of the foregoing. Control 522 may permit a user to retrieve a video frame or clip (or multiple frames or clips) using a number (or numbers) or other identifier(s).

Player 500 may provide advanced features to perform any of the following functions: horizontally flip a video image; overlay graphical images; compare video; measure speed and distance; other functions; and any suitable combination of the foregoing. Controls for these advanced functions may be provided on video player 500 by, for example, any of graphical action icons 517, 518, 519 and 520, which may be scrolled using controls 516 and/or 521. A plurality of icons (e.g., 508, 509, 510, 511, 512, 513 and 514) for selecting video scenes to play and analyze may be provided. The icons may be scrollable using controls 507 and/or 515 to scroll forward and backward, respectively. In some embodiments, when a user touches either of controls 507 or 515, the video scene to be played is updated with a next video in a database accessible by player 500. When an end of the videos in the database is reached, the scrolling action may be configured to wrap around to a first video scene stored in the database, and display that scene among icons 508-514.

A print button 530 may be included to print a copy of the image being shown on video display window. The image may be printed on an attached or remote printer, or may be sent to a memory device, such as a usb stick, as an image, for example, as a jpeg file. An export button 532 may be included to export a portion of or all of the captured video data.

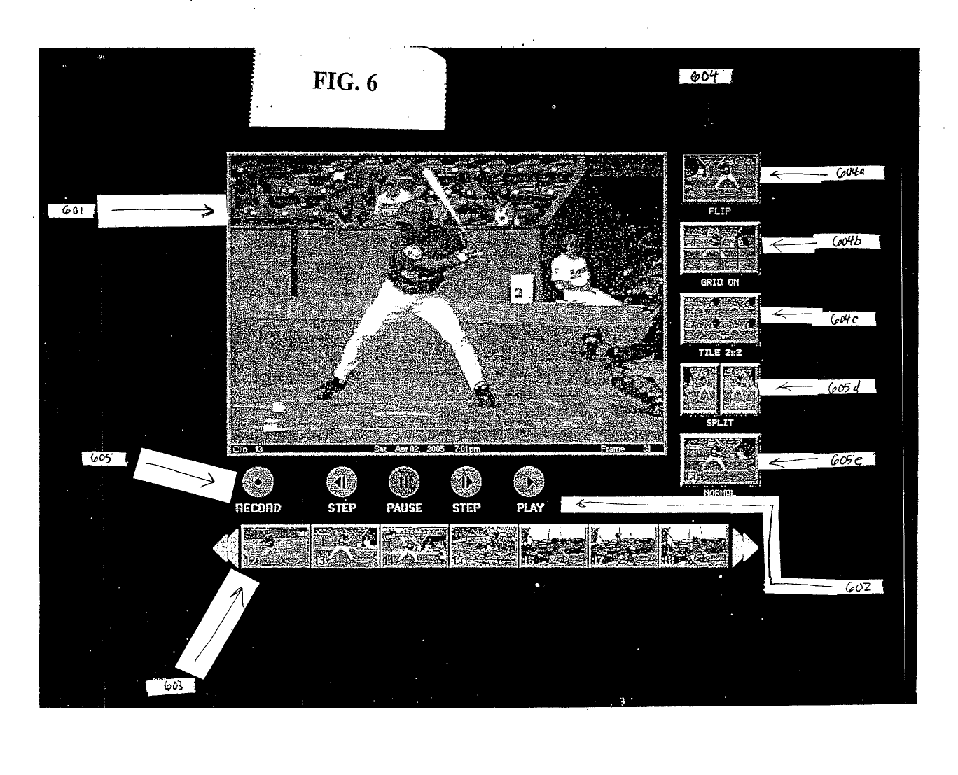

FIGS. 6-9 each are screen shots illustrating an example of a video player, according to some embodiments of the invention.

FIG. 6 illustrates a particular mode of the system which may be used in some embodiments of the invention, i.e., single video player mode of the system.

In single video player mode, there may be only one player window 601 in which video clips are displayed. The video clips displayed in this window may be numbered and dated, and the length of the video clips can range from 1-n frames. While a clip is being played in window 601, the number of the clip, the date it was created and an index for each video frame may be displayed across the bottom of the window 601. Player control buttons 602 may be used by a user to control the action of the video being displayed in window 601. Any of a variety of buttons 602 may be provided, including buttons labeled “pause”, “step” and “play”. In some embodiments, there may be two buttons labeled “step”, one for stepping forward and one for stepping in reverse.

A database of video clips may be provided, and a portion of this database may be displayed in the video icon bar 603. To load a video clip into player window 601, a user may touch one of the icons of icon bar 603, and each icon itself may be a video frame from a video scene.

The loading process may include reading individual frames from the video clips off of a hard drive or a disk. Each frame may be placed in physical memory, and once all the frames are loaded in memory, the loading process may be complete and hard drive or disk access may no longer be required. Thus, faster access may be allowed to local memory, as opposed to accessing a hard drive or a disk.

Further, icon bar 603 may include a left arrow button and a right arrow button with a plurality (e.g., seven) video icons between them. When a user presses the right arrow button, the icons may shift to the left one spot, and the icon furthest to the right may be loaded with a scene from the database. The opposite action may occur when the user presses the left arrow button.

Along the right side of the player or elsewhere, a list of buttons 604 may be provided that allow the user to manipulate video as it is being played. A flip button 604a displays a scene from the current video clip with the horizontal resolution flipped. When a user touches this video button, the video in the window 601 flips and shows a mirror image of the video.

A grid button 604b plays a scene from the current running video with a grid laid over it. Touching this button puts a grid over the video being displayed in window 601, and touching the grid button while a grid is already displayed within window 601 removes the grid from the window.

A tile button 604c may display a scene from the current video clip broken up into four separate windows painted within the button 604c. When a user touches tile button 604c, the video on the screen may split into four separate scenes where each scene is one frame apart from the other. If a user touches the tile button 604c again, the tiles may increase from four to nine separate scenes, and if the button is touched again, the number of scenes may increase from nine to sixteen. This progression may continue to a certain threshold number of scenes being displayed in window 601. The threshold number of scenes may be predefined in some embodiments. When this threshold (e.g., sixteen scenes) has been reached, the next time the button 604c is pressed, it may return window 601 to a single scene view. Control of the tile view with regard to pause, play and step also may be realized.

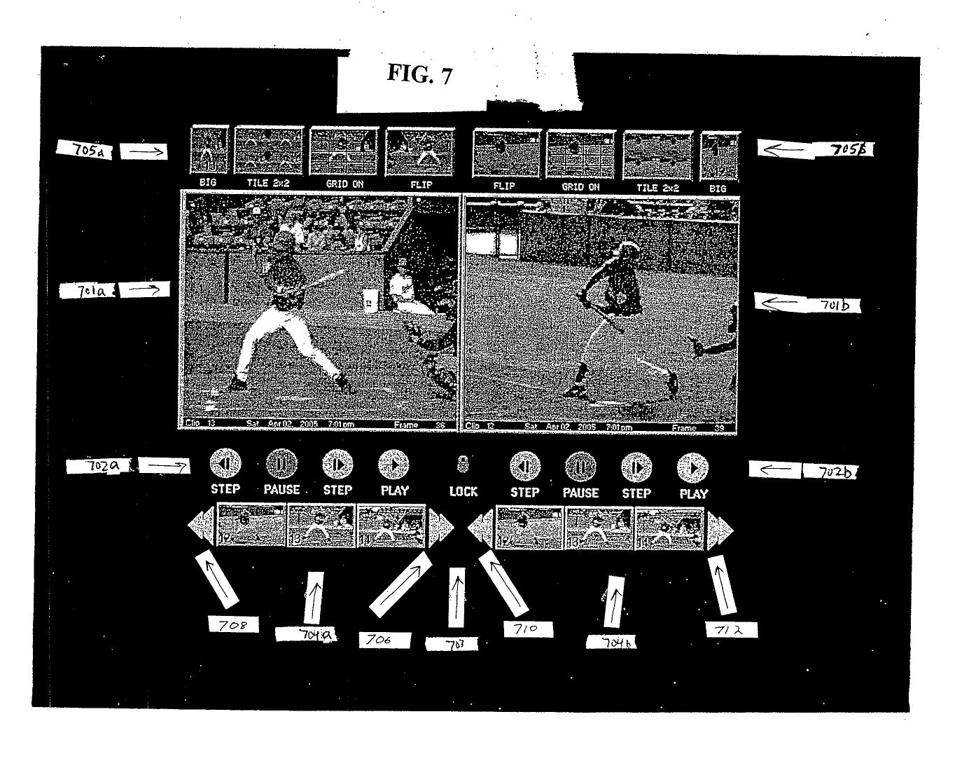

A split button 604d displays a scene from the current running video clip, broken up into two windows displayed on the button itself. When a user touches this button, the system switches from single player mode to dual player mode, for example, as illustrated in FIG. 7.

A normal button 604e displays a scene from the current video clip. When this button is pressed on the current video clip in window 601, the clip is refreshed and played from the beginning with no manipulation features turned on. The video player illustrated in FIG. 6 may include any of a plurality of other buttons and features, including angles, circles, straight lines, colors, print, zoom, print, overlay, audio blackout, etc.

Record button 605, when pressed, switches the system from video player mode to video capture mode.

FIG. 7 illustrates an example of a video player (e.g., video player 500) in dual player mode. In dual player mode, the system may be configured to provide a split-screen mode where there are two copies of the video player running and visible to a user. When the system is in split-screen mode, as illustrated in FIG. 7, the user can load either the same video in each window 701a and 701b, or different videos in each window. In split-screen mode, there are two sets of control buttons 702a and 702b, one to control the left-side player window and one to control the right-side player window, respectively.

A lock button 703 is a button that a user can touch, and when touched, synchronizes the action in each of the two windows 701a and 702b, according to the user pressing step, pause and play either set of controls 702a and 702b.

Across the bottom of the screen, on the left-side side below the player window on the left is a set of buttons 704a including a right arrow button 706 that shifts all three scenes in 704a to the left one spot. The scene furthest to the right is then loaded from the database. The opposite action occurs when the user presses a left arrow button 708. On the right-side bottom of the screen, below the player on the right, is a set of buttons 704b including a left arrow button 710 followed by three video scene buttons and a right arrow button 712. When the user presses right arrow button 712, all three scenes in 704b shift to the left one spot, and the scene furthest to the right is loaded with the next scene from the database. The opposite action occurs when the user presses the left-arrow button 710.

Across the top of the screen on the left-hand side there are manipulation buttons 705a for the tiling, flipping, and putting a grid over the video shown in player window 701a. These buttons have the same affect as in single player mode. There is also a button labeled “BIG” which when touched shuts off split-screen mode and returns to single player mode for the scene illustrated in screen 701a.

On the top right-hand side of FIG. 7, manipulation button 705b may be used for tiling, flipping and putting a grid over the video shown in the player window 701b. These buttons have the same effect as in single player mode. There is also a button labeled “BIG”, which when touched switches the mode to single player mode for the video shown in windows 701b.

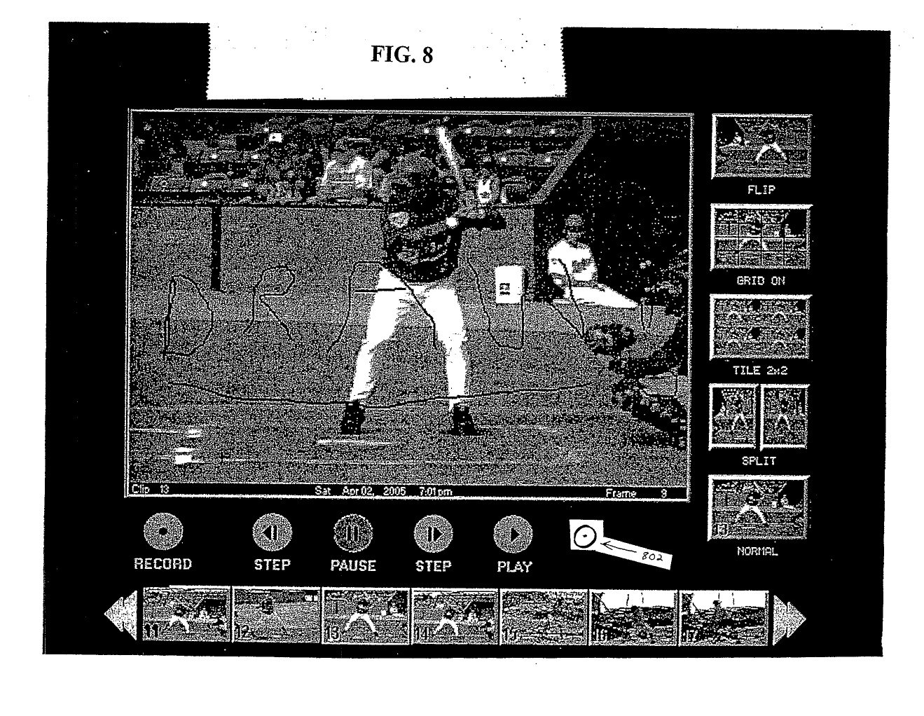

FIG. 8 illustrates an example of the capability provided by a video player (e.g., player 500) to draw on a video scene in a window. For example, a user can draw on the image displayed within the window by merely touching it, for example, with a finger or stylus. The video player may permit a user to draw with more than one color in some embodiments. For example, a button 802 may be included on the touch sensitive screen to change the color of lines produced by a stylus or finger. In other embodiments, a button may be provided on a stylus to effect a color change.

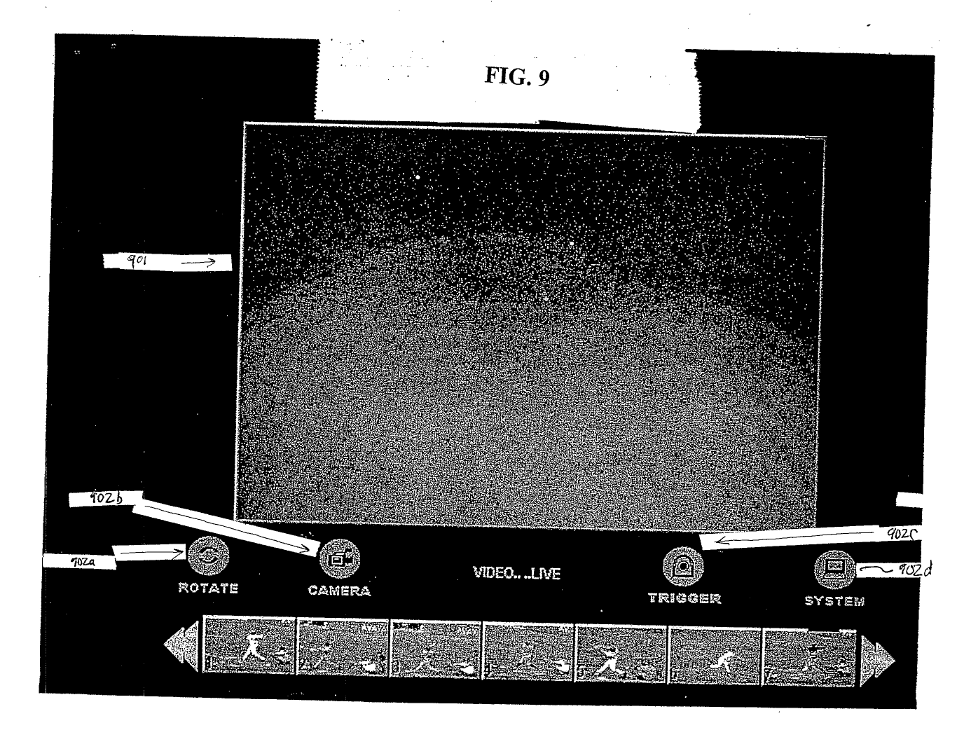

FIG. 9 illustrates an example of a capturing mode of the system, including a capture-viewing window 901, which may display live data as it streams through the system. Video data may be stored in memory which is updated at a certain rate such as, for example, 30 times per second, or a higher or lower rate. Contents of the memory may be saved to disk when a user executes a trigger event, which may dump the memory buffer to disk where a file is created to be used by the player windows.

A rotate button 902a may be provided that, when pressed, rotates the horizontal resolution of the live video being displayed to display a mirrored image of the live video. When the rotate button is pressed again, the live video may switch back to the previous view.

A camera button 902b may be provided and, when pressed, may switch the video displayed in window 901 from a first video feed to a second video feed. When the button is pressed again, it may switch back to the other feed. Thus, if the system includes two cameras capturing motion from two different angles, the user may have the ability to toggle between the two angles as the video is being captured.

A trigger button 902c may be provided and, when pressed, live video being displayed in window 901 may be dumped to disk, and the control and load button used by the player (as described above) may be created.

A system button 902d may be provided and, when pressed, may present a password window. The password window may show 10 buttons labeled 0-9. The user may touch one of the numbers to enter the password, and if it is correct, the system may switch to system (i.e., utility) mode. This mode allows someone with the proper authority to reconfigure the system.

There are other features of the invention that are not illustrated in FIGS. 6-9. For example, a capture-instant replay feature may be enabled. Using the feature, when a user executes a trigger event, the video which has been captured may be displayed one time for review in the capture window. The instant reply feature may be turned on or off.

Each time the system is powered on, default settings previously defined by a user may be automatically set. For example, a user may set a default setting for the length of recording, or set a toggle for instant replay to always be on, etc. These and others setting then may be automatically set each time the system is powered on.

System (i.e., utility) mode may provide the ability to delete video clips, rearrange the order of video clips, play back a range of video clips, update the system software, reset the password for entering system mode and set the recording time for the length of video clips.

A remote broadcast feature may be provided by the system, which broadcasts the video being displayed in the video player and capture windows to remote devices such as a DVD recorder, a VCR, a television, or any other device that accepts a standard NTSC signal. In some embodiments, video may be provided to a display device configured and arranged to be simultaneously viewable by at a hundred fans or more (e.g., one thousand, ten thousand or fifty thousand fans) of an athletic event. Methods described herein acts thereof and various embodiments and variations of these methods and these acts, individually or in combination, may be defined by computer-readable signals tangibly embodied on or more computer-readable media such as, for example, non-volatile recording media, integrated circuit memory elements, or a combination thereof. Computer-readable media can be any available media that can be accessed by a computer. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Computer-readable signals embodied on one or more computer-readable media may define instructions, for example, as part of one or more programs, that, as a result of being executed by a computer, instruct the computer to perform one or more of the functions described herein and/or various embodiments, variations and combinations thereof. Such instructions may be written in any of a plurality of programming languages, for example, Java, J#, Graphical Basic, C, C#, or C++, Fortran, Pascal, Eiffel, Basic, COBOL, other programming languages, or any of a variety of combinations thereof. The computer-readable media on which such instructions are embodied may reside on one or more of the components of any of systems described herein, may be distributed across one or more of such components, and may be in transition therebetween.

The computer-readable media may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement aspects of the present invention discussed above.

It should be appreciated that any single component or collection of multiple components of a computer system that perform the functions described herein can be generically considered as one or more controllers that control such functions. The one or more controllers can be implemented in numerous ways, such as with dedicated hardware and/or firmware, using a processor that is programmed using microcode or software to perform the functions recited above or any suitable combination of the foregoing.

Various embodiments according to the invention may be implemented on one or more computer systems. These computer systems, may be, for example, general-purpose computers such as those based on Intel PENTIUM-type processor, Motorola PowerPC, Sun UltraSPARC, Hewlett-Packard PA-RISC processors, any of a variety of processors available from Advanced Micro Devices (AMD) or any other type of processor. It should be appreciated that one or more of any type of computer system may be used to implement various embodiments of the invention.

A general-purpose computer system according to one embodiment of the invention is configured to perform one or more of the functions described above. It should be appreciated that the system may perform other functions and the invention is not limited to having any particular function or set of functions.

Aspects of the invention may be implemented in software, hardware or firmware, or any combination thereof. Further, such methods, acts, systems, system elements and components thereof may be implemented as part of the computer system described above or as an independent component.

It should be appreciated that the invention is not limited to executing on any particular system or group of systems, and that the invention is not limited to any particular distributed architecture, network, or communication protocol.

Various embodiments of the present invention may be programmed using an object-oriented programming language, such as SmallTalk, Java, J# (J-Sharp), C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any suitable combination thereof. Further, various embodiments of the invention may be implemented using Microsoft.NET technology available from Microsoft Corporation.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A system for capturing and reviewing a recording of a person performing an action, comprising:
an image capturing device to capture the recording of the action;
a display device having a touch screen;
a user interface to control a display of the recording on the display device, and to enable a user to manipulate the presentation of the recording using the touch screen;
at least one transmission medium enabling communication between the image capturing device to the user interface;
at least one mounting mechanism to mount the image capturing device and the touch screen display in a location proximate to the person.

2. The system of claim 1, further comprising:
a triggering controller to control a stopping of the capturing of the recording,
wherein the user interface is operative to initiate, in response to the stopping of the recording, a providing of the display and the enabling of the manipulation.

3. The system of claim 2, wherein the user interface is operative to initiate the providing of the display and the enabling of the manipulation in less than one second from the stopping of the capturing.

4. The system of claim 3, wherein the user interface is operative to initiate the providing of the display and the enabling of the manipulation in less than 500 milliseconds from the stopping of the capturing.

5. The system of claim 1, wherein the action is an athletic action.

6. The system of claim 5, wherein the athletic action is one of the following: a swinging of a golf club; a swinging of a baseball or cricket bat; and a throwing of a ball.

7. The system of claim 1, wherein the at least one mounting mechanism is operative to mount the touch screen display at a height suitable for viewing and touching by the person.

8. A system for enabling a user to review, on a visual display device having a touch screen, a visual recording of a person performing an action, the system comprising:
a user interface to control a display of the recording on a display device and to enable a user to manipulate the presentation of the recording using the touch screen, the display comprising:
a main display of a primary presentation of the recording;
a plurality of user-selectable playback controls;
one or more user-selectable manipulation icons for manipulating a presentation of the recording in the main display; and
one or more user-selectable file icons, each file icon representing a particular recording and enabling a user to select the particular recording for display in the main display.

9. The system of claim 8, further comprising:
a triggering controller to control a stopping of the capturing of the recording,
wherein the user interface is operative to initiate, in response to the stopping of the recording, one or more of the following: displaying the stopped recording in the main display; controlling the one or more user-selectable manipulation icons to be specific to the stopped recording; and adding a file icon representing the stopped recording to the one or more user-selectable file icons.

10. The system of claim 8, wherein the one or more user-selectable file icons comprise graphical content and the graphical content for each user-selectable file icon comprises visual data from the respective particular recording.

11. A system for controlling a recording of footage of a person performing an action, comprising:
an image recording controller to receive, concurrently to a capturing of a portion of the footage by an image capture device, one or more video signals from the image capturing device, the one or more signals representing at least a portion of the footage, the image recording controller operative to temporarily buffer the one or more video signals in memory; and
a triggering controller to control, in response to the capturing of a sound having a particular one or more characteristics, a stopping of the buffering of the one or more video signals and a storing of the buffered one or more video signals on a non-volatile recording medium.

12. The method of claim 11, wherein the triggering controller is operative to control the stopping of the buffering of the one or more video signals and the storing of the buffered one or more video signals on a non-volatile recording medium in response to one or more user events.

13. The system of claim 12, further comprising:
a user interface to initiate, in response to the capturing of the sound, a display of the captured footage on a display device.

14. The system of claim 13, wherein the user interface is operative to enable a user to manipulate the display of the footage in response to the capturing of the sound.

15. The system of claim 13, wherein the user interface comprises one or more icons having graphical content, the graphical content comprising images captured by the image capture device.
